(19) United States
(12) Patent Application Publication
(10) Pub. No.: US 2007/0295528 A1
(43) Pub. Date: Dec. 27, 2007

(54) Pb-free Sn-based material, wiring conductor, terminal connecting assembly, and Pb-free solder alloy

(75) Inventors: Hajime Nishi, Hitachi (JP); Takayuki Tsuji, Hitachi (JP); Hiroshi Yamanobe, Hitachi (JP); Hiroshi Okikawa, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/806,788

(22) Filed: Jun. 4, 2007

(30) Foreign Application Priority Data
Jun. 26, 2006 (JP) 2006-175279
Feb. 26, 2007 (JP) 2007-045927

(51) Int. Cl. H01B 7/00; B23P 19/04; C22C 13/00; C22C 13/02

(52) U.S. Cl. 174/126.4; 29/747; 420/557; 420/561; 420/562

(57) ABSTRACT

A Pb-free Sn-based material part of a wiring conductor is provided at least at a part of a surface the wiring conductor, and the Sn-based material part includes a base metal doped with a transformation retardant element and an oxidation control element. The transformation retardant element is at least one element selected from a group consisted of Sb, Bi, Cd, In, Ag, Au, Ni, Ti, Zr, and Hf. The oxidation control element is at least one element selected from a group consisted of Ge, P, Zn, Kr, Cr, Mn, Na, V, Si, Al, Li, Mg and Ca. The wiring conductor is reflow processed, such that at least one of the Sn, the transformation retardant element and the oxidation control element is diffused to form an alloy.

The present application is based on Japanese Patent Application No. 2006-175279 filed on Jun. 26, 2006 and Japanese Patent Application No. 2007-045927 filed on Feb. 26, 2007, the entire contents of which are incorporated herein by reference.

### BACKGROUND OF THE INVENTION

1. Field of the Invention

The present invention relates to a Pb-free Sn-based material, a wiring conductor, a terminal connecting assembly, and a Pb-free solder alloy, in more particular, to a Pb-free Sn-based material, a wiring conductor, a method for fabricating the same, a terminal connecting assembly, and a Pb-free solder alloy used for electronic devices.

2. Description of the Related Art

Conventionally, a plating of Sn, Ag, Au or Ni is provided on a wiring material, in particular, on a surface of the wiring material comprising copper or copper alloy, so as to prevent the wiring material from oxidation. For example, as shown in FIG. 6, the plating is provided on a connector pin (metal terminal) 12 of a connector (connector member) 11 and on a surface of a conductor 14 of a flexible flat cable (hereinafter, referred as “FFC”) 13, in a terminal connecting assembly (terminal connecting part) for connecting the connector 11 and the FFC 13. Among the materials for plating, Sn is advantageous since the cost is low, and Sn is excellent in industrial properties. Therefore, the wiring material on which the Sn-plating is provided at its surface is generally and broadly employed. For the alloy for such a Sn-plating, a Sn—Pb alloy having an excellent whisker resistance property has been conventionally used. Herein, the “whisker” is a needle-like crystal of Sn, which is generated when a stress is applied to a Sn-based material part.

However, in late years, use of Pb-free materials (non-lead materials) and non-halogen materials is requested from the viewpoint for addressing the environmental concerns. Therefore, application of the Pb-free materials and non-halogen materials is demanded for various materials employed for the wiring materials.

However, in accordance with the application of Pb-free Sn-plating, a whisker which is a needle like crystal of Sn is generated from the plating particularly in a pure Sn-plating. As shown in FIG. 7, there is a risk that adjacent wiring materials (conductors 14) are short-circuited by whiskers 21. Accordingly, there are proposed several techniques for reducing the whisker by conducting a reflow process (i.e. melting and re-solidifying process) on the Sn-plating provided by electroplating or the like, so as to relax an applied stress in the Sn-plating which causes the whisker.

The conventional arts are disclosed by Japanese Patent Laid-Open No. 2001-131663, Japanese Patent Laid-Open No. 2002-317295, Japanese Patent Laid-Open No. 2003-211283, Japanese Patent Laid-Open No. 2000-208934, and Japanese Patent Laid-Open No. 2003-129278.

However, mechanisms of generating the whisker and reducing (suppressing) the whisker are not understood precisely. Further, in the case where an additional external stress is applied to a part of a connector in which the Sn-plated wiring conductor is fitted, even if the reflow process is conducted, the generation of the whisker cannot be suppressed. At present, any effective technique for solving this problem has not been found.

### SUMMARY OF THE INVENTION

Accordingly, for solving the above problems, the object of the present invention is to provide a Pb-free Sn-based material, a wiring conductor, a terminal connecting assembly, and a Pb-free solder alloy, in which generation of the whisker can be suppressed at a surface of the Pb-free Sn-based material.

According to a first feature of the present invention, a Pb-free Sn-based material comprises:

a base metal doped with a first dopant comprising a transformation retardant element which retards a transformation of a crystal structure, and a second dopant comprising an oxidation control element which is different from the transformation retardant element.

According to this structure, it is possible to suppress a crystal structure transformation or an oxidation of the Pb-free Sn-based material which involves a volume expansion, and to suppress a strain energy generated within the Pb-free Sn-based material when using the Pb-free Sn-based material. Herein, the first dopant comprises an element for retarding the crystal structure transformation (hereinafter, referred as “transformation retardant element”), and the second dopant comprises an element for suppressing an oxidation of a metal base of a metallic member (hereafter, referred as “oxidation control element”).

In the Pb-free Sn-based material, the oxidation control element may comprise at least one element selected from a group consisted of Sb, Bi, Cd, In, Ag, Au, Ni, Ti, Zr, and Hf, and the oxidation control element comprises at least one element selected from a group consisted of Ge, Zn, P, K, Cr, Mn, Na, V, Si, Al, Li, Mg and Ca.

In the Pb-free Sn-based material, it is preferable that a doping amount of the first dopant is not more than 10 wt %, and a doping amount of the second dopant is not more than 10 wt %.

Further, a doping effect is insufficient when the doping amount is too little, and conductivity, physical strength and the like of the Sn-based material are influenced when the doping amount is too much. Therefore, it is more preferable that the respective doping amounts are from 0.1 to 1.0 wt %.

Still further, for suppressing the generation of the whisker under conditions of a normal room temperature leaving test (3000 hr), a thermal shock test (3000 cycles), and a humidity resistance leaving test (3000 hr), it is required that the doping amount of the oxidation control element doped to the Sn-based material part base metal is not less than 0.01 wt %, and particularly the doping amount of the transformation retardant element is greater than that of the oxidation control element. In more concrete, the doping amount of the transformation retardant element is preferably not less than 0.1 wt %, and more preferably not less than 1.0 wt %.

According to a second feature of the invention, a wiring conductor comprises:

a Sn-based material part provided at least at a part of its surface, the Sn-based material part comprising a base metal doped with a first dopant comprising at least one element selected from a group consisted of Sb, Bi, Cd, In, Ag, Au, Ni, Ti, Zr, and Hf, and a second dopant comprising at least one element selected from a group consisted of Ge, Zn, P, K, Cr, Mn, Na, V, Si, Al, Li, Mg and Ca;

wherein at least one of the Sn, the first dopant and the second dopant is diffused.

According to this structure, it is possible to suppress a transformation of the Sn-based material part (βSn) having a body-centered tetragonal crystal structure (when manufactured) into αSn having a diamond type crystal structure, and a volume expansion of the Sn-based material part due to the oxidation, when using the Pb-free Sn-based material part at a temperature lower than an allotropic transformation point including a room temperature.

In the wiring conductor, it is preferable that a doping amount of the first dopant is not more than 10 wt %, and a doping amount of the second dopant is not more than 10 wt %.

In the wiring conductor, at least one of the Sn, the first dopant and the second dopant may be diffused by a reflow process.

The wiring conductor may further comprise:

a core composed of a Cu-based material;

wherein the core is coated with a coating layer composed of the Sn-based material part.

In the wiring conductor, the Sn-based material part may comprise a solder material or a brazing-filler material.

According to a third feature of the invention, a wiring conductor comprises:

a metal conductor;

a Sn-based material part provided at least at a part of a surface of the metal conductor;

a first layer including a first dopant comprising at least one element selected from a group consisted of Sb, Bi, Cd, In, Ag, Au, Ni, Ti, Zr, and Hf; and

a second layer including a second dopant comprising at least one element selected from a group consisted of Ge, Zn, P, K, Cr, Mn, Na, V, Si, Al, Li, Mg and Ca;

wherein at least one of the Sn, the first dopant and the second dopant is diffused.

According to this structure, it is possible to suppress a transformation of the Sn-based material part (βSn) having a body-centered tetragonal crystal structure (when manufactured) into αSn having a diamond type crystal structure, and a volume expansion of the Sn-based material part due to the oxidation, when using the Pb-free Sn-based material part at a temperature lower than an allotropic transformation point including a room temperature.

In the wiring conductor, the first layer and the second layer may be provided on the metal conductor.

In the wiring conductor, the first layer and the second layer may be provided on the Sn-based material part.

In the wiring conductor, the first layer may be provided on the second layer.

In the wiring conductor, the second layer may be provided on the first layer.

According to a fourth feature of the invention a connecting assembly comprises:

a terminal to be connected to another terminal, at least one of the terminals comprising a wiring conductor,

wherein the wiring conductor comprises:

a Sn-based material part provided at least at a part of its surface, the Sn-based material part comprising a base metal doped with a first dopant comprising at least one element selected from a group consisted of Sb, Bi, Cd, In, Ag, Au, Ni, Ti, Zr, and Hf, and a second dopant comprising at least one element selected from a group consisted of Ge, Zn, P, K, Cr, Mn, Na, V, Si, Al, Li, Mg and Ca;

wherein at least one of the Sn, the first dopant and the second dopant is diffused.

In the connecting assembly, the terminal to be connected may be a terminal of a metallic conductor, and a surface of the terminal may be coated with the wiring conductor. The terminals to be connected to each other are physically contacted with each other.

In the connecting assembly, one of the terminals to be connected to each other may be a connector pin of a connector.

In the connecting assembly, the metallic conductors may be joined with a solder joint using the aforementioned solder material. The metallic conductors may be electrically joined by brazing using the aforementioned brazing-filler material.

According to a fifth feature of the invention, a Pb-free solder alloy comprises:

Ag of 0.1 to 5 wt %;

Cu of 0.1 to 5 wt %;

a first dopant of not more than 10 wt %, the first dopant comprising at least one element selected from a group consisted of Sb, Bi, Cd, In, Ag, Au, Ni, Ti, Zr, and Hf;

a second dopant of not more than 10 wt %, and the second dopant comprising at least one element selected from a group consisted of Ge, Zn, P, K, Cr, Mn, Na, V, Si, Al, Li, Mg and Ca; and

Sn as a remaining part.

According to the present invention, it is possible to provide a Pb-free Sn-based material, a wiring conductor, a terminal connecting assembly, and a Pb-free solder alloy, in which a connecting reliability at a terminal connecting part is high. Further, it is possible to reduce a stress generated in a Pb-free Sn-based material part of a wiring conductor provided at least at a part of a surface of the wiring conductor for electronic devices. As a result, the generation of the whisker can be suppressed, so that defects such as a short circuit between adjacent conductors in the wiring material for electronic devices can be solved.

### BRIEF DESCRIPTION OF THE DRAWINGS

The present invention will be explained in more detail in conjunction with appended drawings, wherein:

FIG. 1 is a cross sectional view along a widthwise direction of a wiring conductor in a first preferred embodiment according to the present invention;

FIG. 2 is a cross sectional view along a widthwise direction of a wiring conductor in a second preferred embodiment according to the present invention;

FIG. 3 is a cross sectional view along a widthwise direction of the wiring conductor before reflow process in the second preferred embodiment according to the present invention;

FIG. 4 is a cross sectional view along a widthwise direction of a wiring conductor before reflow process in a variation of the second preferred embodiment according to the present invention;

FIGS. 5A to 5E are explanatory diagrams showing a method for fabricating a wiring conductor in the second preferred according to the present invention;

FIG. 6 is a schematic diagram showing an example where a FFC is fitted into a connector; and

FIG. 7 is a schematic diagram of a fitting part between connector pins and wirings, wherein whiskers are generated and adjacent wirings are short-circuited.

### DESCRIPTION OF THE PREFERRED EMBODIMENTS

Preferred embodiments according to the present invention will be explained in detail hereinafter by referring to the appended drawings.

Sn is used as a base metal of a Sn-plating which is usually used as a plating material of a wiring material. Sn has a two crystal structure types: βSn having a body-centered tetragonal crystal structure (white tin, density of 7.3 g/cm³); and αSn having a diamond type crystal structure (gray tin, density of 5.75 g/cm³). Since an allotropic transformation point where βSn transforms into αSn (hereinafter, referred as “β to α transformation”) is around 13° C. (or less), βSn when manufactured transforms into αSn when used at a temperature not more than the allotropic transformation point. Further, there are two types of Sn oxides each having an oxidation number of 2 and an oxidation number of 4, namely SnO (tin (II) oxide, density of 6.45 g/cm³) which is a black tetragonal crystal, and SnO₂ (tin (IV) oxide, density of 6.95 g/cm³) which is a colorless tetragonal crystal.

The whisker is a needle like crystal of Sn as described above. Inventors of the present invention zealously studied this problem. As a result of the studies, as for the generation of the whisker at a surface of the Sn-plating film, it is founded one of the causes of the whisker is a volume expansion in accordance with the β to α transformation or the oxidation of Sn. In particular, the β to α transformation easily occurs, so that 27% of volume expansion is caused at a region of the Sn-plating film to which an external force is applied. Under a high temperature and high humidity condition or the like, Sn is oxidized to form an oxide, so that 28% of volume expansion is caused when the tin oxide is SnO and 33% of volume expansion is caused when the time oxide is SnO₂. In accordance with the volume expansion, Sn atoms having nowhere to go are grown to be columnar outside the Sn-plating, thereby forming a whisker. Accordingly, the Inventors found that the generation of the whisker can be suppressed by retarding the β to α transformation or the oxidation of Sn.

As an element for retarding the β to α transformation (transformation retardant element), Pb, Sb, Bi, Cd, In, Ag, Au, and Ni are known, as described in for example, W. Lee Williams, “GRAY TIN FORMATION IN SOLDERED JOINTS STORED AT LOW TEMPERATURE”, SYMPOSIUM ON SOLDER, Alfred Bornemann, “TIN DISEASE IN SOLDER TYPE ALLOYS”, SYMPOSIUM ON SOLDER (1956), and C. E. Hormer and H. C. Watkins, “Transformation of Tin at Low Temperatures”, THE METAL INDUSTRY, 1942, vol. 60, pp. 364-366 and the like. It is assumed that each of these elements except Ni has an effect of suppressing the β to α transformation which involves the volume expansion, since each of these elements has an atomic radius greater than that of Sn. Other than these elements, Ti, Zr, and Hf are elements each having an atomic radius greater than that of Sn. In the present invention, it is premised that the wiring material should be Pb-free, Sb, Bi, Cd, In, Ag, Au, Ni, Ti, Zr, and Hf are used as the transformation retardant element.

As for an element suppressing oxidation (oxidation control element), it is possible to use Ge, P, K, Zn, Cr, Mn, Na, V, Si, Ti, Al, Li, Mg, Ca, and Zr each having an oxidative tendency greater than that of Sn as read from Elingham diagram. It is assumed that each of these elements has an effect of suppressing the oxidation of Sn which involves the volume expansion, since each of these elements has an oxidative tendency greater than that of Sn.

Next, a Pb-free Sn-based material and a wiring conductor in a first preferred embodiment will be explained.

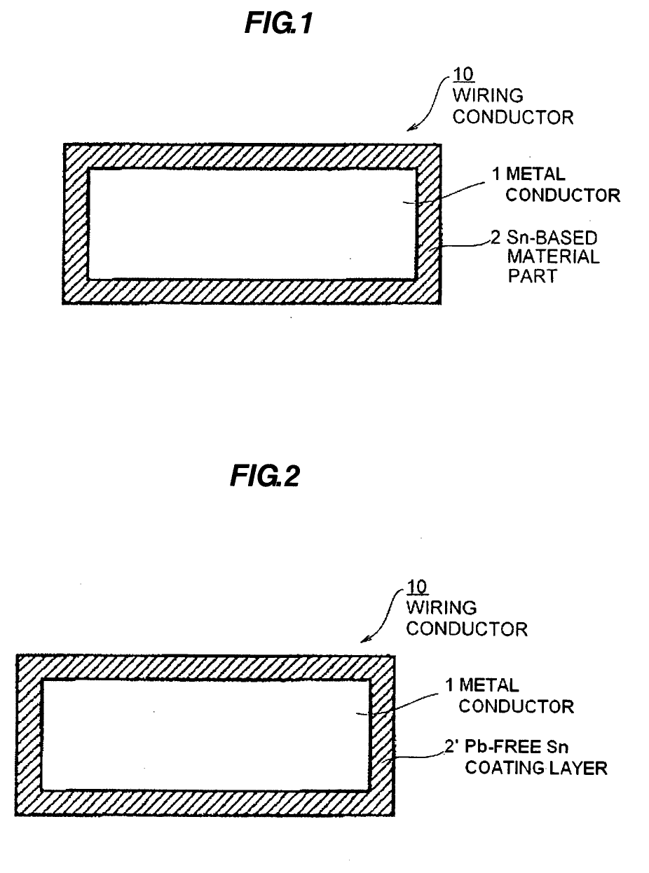

FIG. 1 is a cross sectional view along a widthwise direction of a wiring conductor in the first preferred embodiment according to the present invention.

A Pb-free Sn-based material in the first preferred embodiment according to the invention comprises a base metal composed of Sn-based material doped with a transformation retardant element (first additive component element) for retarding a transformation of a crystal structure, and an oxidation control element (second additive component element) for suppressing an oxidation. The transformation retardant element and the oxidation control element are different from each other.

A wiring conductor in the first preferred embodiment is a metal conductor consisted of the Pb-free Sn-based material, or the metal conductor covered with the Pb-free Sn-based material at its surface. The wiring conductor here is a metal conductor such as wiring material, cable conductor, printed circuit board and the like.

In more concrete, as shown in FIG. 1, the wiring conductor 10 according to the preferred embodiment comprises a core (metal conductor) 1 and a Pb-free Sn-based material part 2 at least at its surface. The Pb-free Sn-based material part 2 comprises a base metal doped with a transformation retardant element comprising at least one element selected from a group consisted of Sb, Bi, Cd, In, Ag, Au, Ni, Ti, Zr, and Hf and an oxidation control element comprising at least one element selected from a group consisted of K, Cr, Mn, Na, V, Si, Al, Li, Mg and Ca.

As for the wiring conductor, a wiring member comprising a core composed of a Cu-based material, and a coating layer composed of a Sn-based material part and provided around the core, a wiring member totally composed of the Sn-based material part (solder material or brazing-filler material), or the like may be proposed. As for the wiring member, for example, various wiring members for electronic devices such as a flexible flat cable (FFC), a flexible printed circuit (FPC), a multi frame joiner (MFJ) that is a printed circuit board in which an insulator is applied on a metal, a printed circuit board, a power supply board (PSB) that is a member in which a wiring is installed on an insulator, a small diameter coaxial cable, antenna cable, or the like may be proposed.

A base metal of the Sn-based material part may be any one of a pure Sn and a Sn alloy. Further, a doping ratio of each of the transformation retardant element and the oxidation control element doped to the Sn-based material part base metal is from 0.001 to 10 wt %, and preferably around 0.1 wt % (or from 0.01 to 1.0 wt %). When the doping ratio of the transformation retardant element or the oxidation control element in the Sn-based material part is less than 0.001 wt %, the effect of retarding the β to α a transformation or the effect of suppressing the oxidation cannot be sufficiently realized. On the contrary, when the doping ratio of the transformation retardant element or the oxidation control element in the Sn-base material part base metal is greater than 10 wt %, there will be defects such as generation of cracks, deterioration of solderability, or the like.

For suppressing the generation of the whisker under conditions of a normal room temperature leaving test (3000 hr), a thermal shock test (3000 cycles), and a humidity resistance leaving test (3000 hr), it is requested that the doping amount of the oxidation control element doped to the Sn-based material part base metal is not less than 0.01 wt %, and particularly the doping amount of the transformation retardant element is greater than that of the oxidation control element. In more concrete, the doping amount of the transformation retardant element is preferably not less than 0.1 wt %, and more preferably not less than 1.0 wt %.

The reason of determining the above ranges may be explained as follows. The oxidation control element can exert the oxidation control effect with a very small amount, since it is sufficient to dope the amount necessary for modifying only a surface of the Sn-plating. On the other hand, the transformation retardant element can exert the effect of retarding the β to α transformation when a doping amount of the transformation retardant element is considerable, since the Sn-plating should be totally doped with the transformation retardant element.

It is preferable that the transformation retardant element and the oxidation control element doped to the Sn-based material part base metal are selected, with considering the work environment and security in manufacturing. As for the transformation retardant element, Sb, Bi, Ag, Au, Ni, Ti, Zr and Hf are more preferable. As for the oxidation control element, Ge, Zn, P, K, Mn, V, Si, Al, Mg, and Ca are more preferable.

As the Sn-based material part base metal, a Pb-free solder alloy base metal may be used. A Pb-free solder alloy (solder material or brazing-filler material) can be obtained, by doping the aforementioned transformation retardant element with a doping ratio of not more than 10 wt % and the oxidation control element with a doping ratio of not more than 10 wt % to the Pb-free solder alloy base metal.

As for the Pb-free solder alloy base metal, for example, Sn-0.1 to 5 wt % Ag-0.1 to 5 wt % Cu alloy (namely, a Sn—Ag—Cu solder alloy comprising Ag of 0.1 to 5 wt % and Cu of 0.1 to 5 wt %) may be used, however, the present invention is not limited thereto. Any existing Pb-free solder alloy is applicable.

Here, In may be doped to the Sn-based material part base metal as the transformation retardant element, so that the β to α transformation can be delayed as well as a melting point of the wiring conductor can be lowered. According to this structure, it is possible to improve a metal flow property and a joint property of the wiring conductor when the wiring conductor is joined to the solder material or the brazing-filler material.

Further, Cu with a doping ratio of e.g. 0.1 to 5.0 wt % may be doped to the Sn-based material part base metal as a dopant in addition to the transformation retardant element and the oxidation control element. According to this structure, it is possible to suppress a solder leach (dissolution of metallization) of the wiring conductor when the wiring conductor is joined to the solder material by solder joint.

Next, a function of the wiring conductor in the first preferred embodiment according to the invention will be explained below.

In a case where the wiring conductor in the first preferred embodiment is a wiring member to be used as a conductor of the FFC, a wiring member comprising a core composed of Cu-based conductor, and a Sn-plating film provided around a periphery of the core, in which the Sn-plating film comprises a Sn-plating base metal doped with a transformation retardant element with a doping ratio of 0.001 to 10 wt % and an oxidation control element with a doping ratio of 0.001 to 10 wt % may be used as the wiring conductor. The wiring conductor according to this structure satisfies the request of realizing the Pb-free Sn plating film, and has a whisker resistance property similar to that of a wiring conductor comprising Sn—Pb alloy (solder) plating film that has an actual performance of the whisker resistance property.

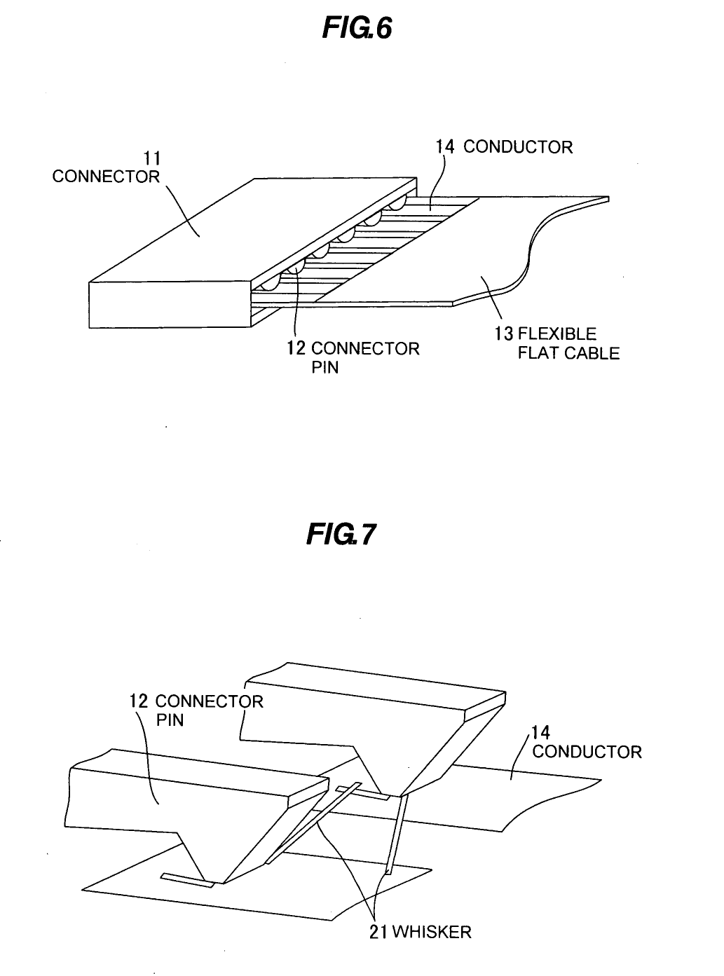

In more concrete, as shown in FIG. 6 when a wiring member such as a FFC 13 comprising the aforementioned Sn-plating film on a conductor 14 is fitted and connected into a connector (connector member) 11 with contacting a connector pin 12 of the connector 11, the generation of the whisker at a surface of the Sn-plating film can be suppressed even if a large compressive stress is applied to the Sn-plating film, since the transformation retardant element retards the β to α transformation of Sn as well as the oxidation control element suppresses the oxidation of Sn. In other words, even in an environment to which a large external stress is applied, for example, a terminal connecting part in which the wiring member is fitted into and contacted with the connector pin, there is little possibility that the whisker is generated at the surface of the Sn-plating film. As a result, the generation of the whisker can be suppressed at the terminal connecting part, and it is possible to avoid defects such as the short circuit between adjacent conductors, thereby improving a connecting reliability of the terminal connecting part.

Further, even if the wiring conductor comprising the aforementioned Sn-plating film is used in cold climates (at a temperature lower than the allotropic transformation point) or at a high temperature (for example, at 85° C. and 85% RH, which is often used in the high temperature test), the β to α transformation and the oxidation which involve a volume variation can be suppressed. Accordingly, the generation of the whisker can be suppressed in the terminal connecting part, and a generation and a residue of a strain energy within the wiring member (wiring conductor) can be suppressed, so that a flex resistance of the terminal connecting part can be kept good.

Next, the Pb-free solder alloy in the first preferred embodiment is a solder material (or a brazing-filler material) for electrically connecting metal conductors, which comprises a solder material base metal doped with a transformation retardant element with a doping ratio of 0.001 to 10 wt % and an oxidation control element with a doping ratio of 0.001 to 10 wt %. In a terminal connecting part in which the metal conductors are electrically connected to each other by using the aforementioned solder material (brazing-filler material), a joint part has a whisker resistance property similar to a joint part comprising Sn—Pb alloy (solder) plating film that has an actual performance of the whisker resistance property. Accordingly, even if the wiring conductor comprising the aforementioned Sn-plating film is used in cold climates (at a temperature lower than the allotropic transformation point) or at a high temperature, the generation of the whisker can be suppressed at the joint part, and it is possible to avoid defects such as the short circuit between adjacent conductors, thereby improving a connecting reliability of the joint part.

Next, a wiring conductor in a second preferred embodiment will be explained.

FIG. 2 is a cross sectional view along a widthwise direction of a wiring conductor in the second preferred embodiment.

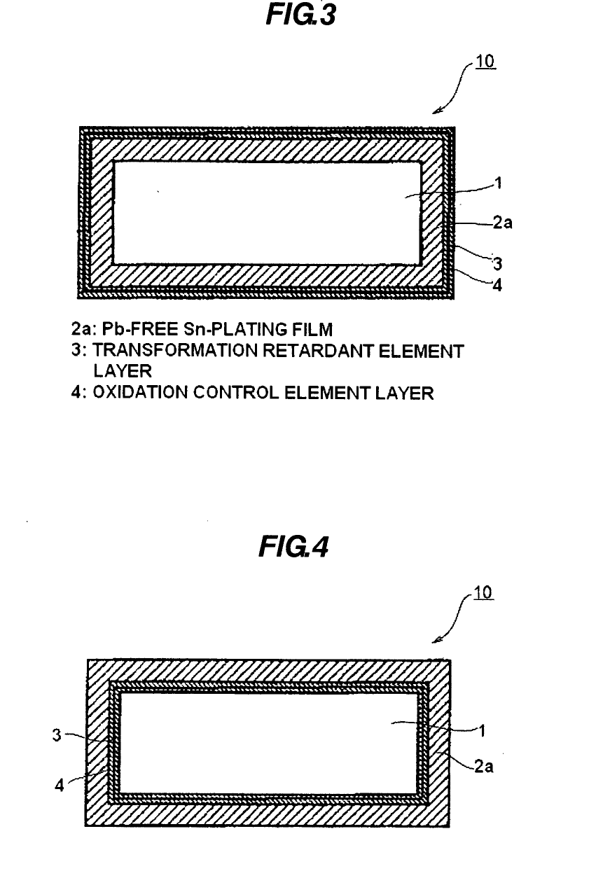

FIG. 3 is a cross sectional view along a widthwise direction of the wiring conductor shown in FIG. 2 before reflow process in the second preferred embodiment.

A wiring conductor 10 in the second preferred embodiment comprises a metal conductor 1, and a Pb-free Sn coating layer 2′ provided at an entire surface of the metal conductor 1. The Pb-free Sn coating layer 2′ is formed by providing a Pb-free Sn-based plating film 2a at an entire surface (or at least at a part of the surface) of the metal conductor 1, and a transformation retardant element layer (transformation retardant plating film) 3 as well as an oxidation control element layer (oxidation control plating film) 4 on the Pb-free Sn-plating film 2a as shown in FIG. 3, and a reflow process is conducted thereon.

The Pb-free Sn coating layer 2′ is a layer mainly composed of the transformation retardant element, the oxidation control element, and a Sn-alloy. The Pb-free Sn coating layer 2′ may be totally composed of an alloy. Further, the Pb-free Sn coating layer 2′ may partially comprise a residue of at least one of the transformation retardant element layer 3, the oxidation control element layer 4, and the Sn-plating film 2a.

A weight ratio of the transformation retardant element layer 3 to that of the Sn-plating film 2a is from 0.001 to 10 wt %, preferably around 0.1 wt % (or from 0.01 to 1.0 wt %). Similarly, a weight ratio of the oxidation control element layer 4 to that of the Sn-plating film 2a is from 0.001 to 10 wt %, preferably around 0.1 wt % (or from 0.01 to 1.0 wt %).

For suppressing the generation of the whisker under conditions of a normal room temperature leaving test (3000 hr), a thermal shock test (3000 cycles), and a humidity resistance leaving test (3000 hr), it is requested that the doping amount of the oxidation control element is not less than 0.01 wt %, and particularly the doping amount of the transformation retardant element is greater than that of the oxidation control element. In more concrete, the doping amount of the transformation retardant element is preferably not less than 0.1 wt %, and more preferably not less than 1.0 wt %.

In the second preferred embodiment, the transformation retardant element layer 3 and the oxidation control element layer 4 are provided on the Sn-plating film 2a. As shown in FIG. 3, the oxidation control element layer 4 may be provided on the transformation retardant element layer 3. Alternatively, the transformation retardant element layer 3 may be provided on the oxidation control element layer 4.

FIG. 4 is a cross sectional view along a widthwise direction of a wiring conductor in a variation of the second preferred embodiment.

As shown in FIG. 4, the transformation retardant element layer and the oxidation control element layer may be provided on the metal conductor 1 and beneath the Sn-plating film 2a. Alternatively, the transformation retardant element layer 3 (or the oxidation control element layer 4) is provided on the Sn-plating film 2a and the oxidation control element layer 4 (or the transformation retardant element layer 3) is provided beneath the Sn-plating film 2.

Next, a method for fabricating a wiring conductor in the second preferred embodiment will be explained.

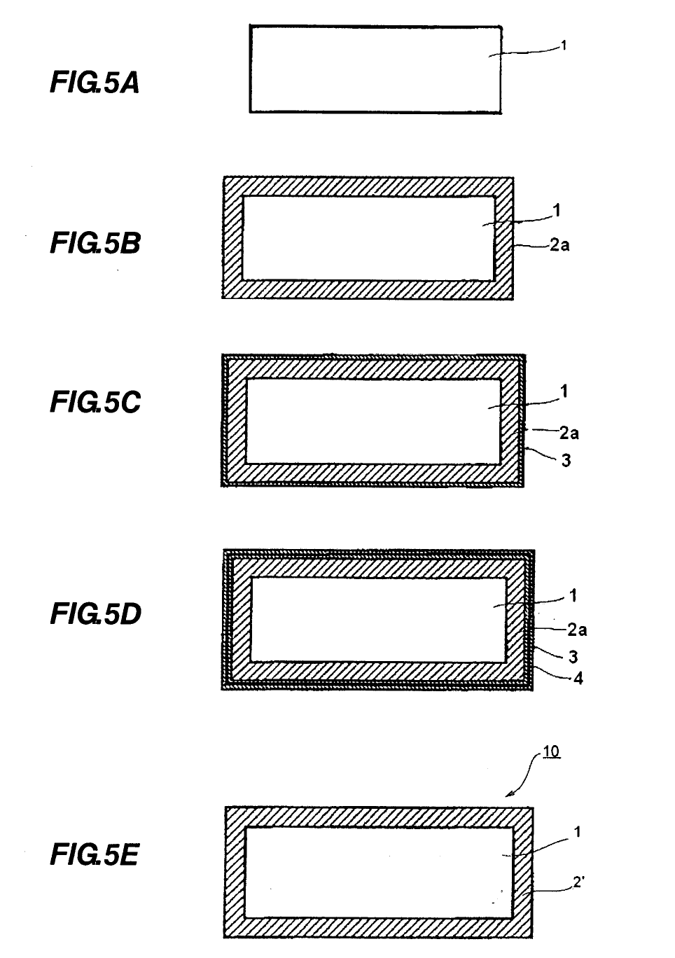

FIGS. 5A to 5E are explanatory diagrams showing the method for fabricating the wiring conductor in the second preferred embodiment.

As shown in FIG. 5A, a metal conductor 1 is firstly prepared.

Then, as shown in FIG. 5B, the metal conductor 1 is plated with a Pb-free Sn-based material, so that a Sn-plating film 2a is provided at least at a part of a surface of the metal conductor 1.

As shown in FIG. 5C, a plating film 3 comprising a transformation retardant element (transformation retardant plating film) is provided on the Sn-plating film 2.

As shown in FIG. 5D, a plating film 4 comprising an oxidation control element (oxidation control plating film) is provided on the transformation retardant plating film 3. Alternatively, the oxidation control plating film 4 may be formed prior to the transformation retardant plating film 3. The order of forming the transformation retardant plating film 3 and the oxidation control plating film 4 is arbitrary.

After appropriately conducting a rolling process, an area reduction process or the like on the metal conductor 1 provided with the Sn-plating film 2a, the transformation retardant plating film 3, and the oxidation control plating film 4, a reflow process (annealing by energization) is conducted thereon. By conducting the reflow process, Sn in the Sn-plating film 2a, the transformation retardant elements in the transformation retardant plating film 3, and the oxidation control elements in the oxidation control plating film 4 are diffused.

As a result, as shown in FIG. 5E, a Sn coating layer 2′ comprising an alloy of Sn-plating film 2a, the transformation retardant plating film 3, and the oxidation control plating film 4 is formed.

Annealing temperature and annealing time of the reflow process are such determined that the temperature and time are enough to diffuse Sn in the Sn-plating film 2, the transformation retardant elements in the transformation retardant plating film 3, and the oxidation control elements in the oxidation control plating film 4. Since the annealing temperature and time are varied in accordance with the transformation retardant element and the oxidation control element to be used, the annealing temperature and time are appropriately adjusted in accordance with the oxidation control element to be used.

The present invention is not limited to the preferred embodiments as described above, and other variations can be expected.

Next, the present invention will be explained in conjunction with following Examples however the present invention is not limited thereto.

### EXAMPLES 1 TO 14, 15, 16, 17 TO 23, 24 TO 30, 31, 32, COMPARATIVE EXAMPLES 1 TO 9, 10 TO 18, AND CONVENTIONAL ART 1

Samples of wiring member were prepared by conducting a fusion welding of a pure Sn doped with following elements. In the sample, a pure Sn is doped with:

(a) 0.01 wt % of a transformation retardant element (any one of Sb, Bi, In, Ag, Au, Ni, Ti, Zr, and Hf) and 0.01 wt % of an oxidation control element (any one of Ge, P, K, Zn, Mn, V, Si, Mg, Al, and Ca), respectively;

(b) 0.01 wt % of a transformation retardant element (Bi), 0.01 wt % of another transformation retardant element (Ni), and 0.01 wt % of an oxidation control element (any one of P and Zn), respectively;

(c) 1 wt % of a transformation retardant element (any one of Sb, Bi, In, Ag, and Au) and 0.01 wt % of an oxidation control element (any one of P, K, Zn, Mn, and V), respectively;

(d) 0.1 wt % of a transformation retardant element (any one of Ni, Ti, Zr, and Hf) and 0.01 wt % of an oxidation control element (any one of Si, P, Zn, Ge, Mg, Al, and Ca), respectively;

(e) 1.0 wt % of a transformation retardant element (Bi), 0.1 wt % of another transformation retardant element (Ni), and 0.01 wt % of an oxidation control element (any one of P and Zn), respectively;

(f) 0.01 wt % of only a transformation retardant element;

(g) 0.01 wt % of only an oxidation control element; and

(h) no dopant.

### EXAMPLES 33 TO 46, 47, 48, 49 TO 55, 56 TO 62, 63, 64, COMPARATIVE EXAMPLES 19 TO 27, 28 TO 36, AND CONVENTIONAL ART 2

Samples of wiring member were prepared by conducting a fusion welding of a Sn-3 wt % Ag-0.5 wt % Cu alloy which is a Pb-free solder material doped with following elements. In the sample, the Sn-3 wt % Ag-0.5 wt % Cu alloy is doped with:

(i) 0.01 wt % of a transformation retardant element (any one of Sb, Bi, In, Ag, Au, Ni, Ti, Zr, and Hf) and 0.01 wt % of an oxidation control element (any one of Ge, P, K, Zn, Mn, V, Si, Mg, Al, and Ca), respectively;

(j) 0.01 wt % of a transformation retardant element (Bi), 0.01 wt % of another transformation retardant element (Ni), and 0.01 wt % of an oxidation control element (any one of P and Zn), respectively;

(k) 1 wt % of a transformation retardant element (any one of Sb, Bi, In, Ag, and Au) and 0.01 wt % of an oxidation control element (any one of P, K, Zn, Mn, and V), respectively;

(l) 0.1 wt % of a transformation retardant element (any one of Ni, Ti, Zr, and Hf) and 0.01 wt % of an oxidation control element (any one of Si, P, Zn, Ge, Mg, Al, and Ca), respectively;

(m) 1.0 wt % of a transformation retardant element (Bi), 0.1 wt % of another transformation retardant element (Ni), and 0.01 wt % of an oxidation control element (any one of P and Zn), respectively;

(n) 0.01 wt % of only a transformation retardant element;

(o) 0.01 wt % of only an oxidation control element; and

(p) no dopant.

In a state where each of the wiring members is fitted into and contacted with a connector, a normal room temperature leaving test (25° C.×1000 hr), a thermal shock test (−55° C. to 125° C.×1000 cycles), and a humidity resistance leaving test (55° C., 95% RH×1000 hr) were carried out.

In addition, for the Examples 17 to 32 and Examples 49 to 64 to which the transformation retardant element of not less than 0.01 wt % is doped, a normal room temperature leaving test (25° C.×3000 hr), a thermal shock test (−55° C. to 125° C.×3000 cycles), and a humidity resistance leaving test (55° C., 95% RH×3000 hr) were carried out.

Thereafter, each of the wiring members was detached from the connector, and a status of generation of whisker at a plating film surface in a connector fitting part (connecting part) was observed by means of electron microscope.

TABLE 1 and TABLE 2 show an evaluation result of whisker resistance property of the wiring members after respective tests. In TABLE 1 and TABLE 2, ⋆ indicates “no whisker” (normal room temperature leaving test: 3000 hr, thermal shock test: 3000 cycles, humidity resistance leaving test: 3000 hr), ⊚ indicates “no whisker” (normal room temperature leaving test: 1000 hr, thermal shock test: 1000 cycles, humidity resistance leaving test: 1000 hr), ◯ indicates that a length of the whisker is less than 50 μm (normal room temperature leaving test: 1000 hr, thermal shock test: 1000 cycles, humidity resistance leaving test: 1000 hr), and X indicates a length of the whisker is not less than 50 μm (normal room temperature leaving test: 1000 hr, thermal shock test: 1000 cycles, humidity resistance leaving test: 1000 hr).

TABLE 1

| | | | | Whisker resistance property | | |
|---|---|---|---|---|---|---|
| | | | | Room | Thermal | Humidity |
| | | | | temperature | shock | resistance |
| Example | | Doping metal | | leaving test | test | leaving test |
| Example | 1 | 0.01 wt % Sb | 0.01 wt % P | ⊚ | ⊚ | ⊚ |
| (Pure Sn + | 2 | 0.01 wt % Bi | 0.01 wt % K | ⊚ | ⊚ | ⊚ |
| Transformation | 3 | 0.01 wt % Bi | 0.01 wt % P | ⊚ | ⊚ | ⊚ |
| retardant | 4 | 0.01 wt % Bi | 0.01 wt % Zn | ⊚ | ⊚ | ⊚ |
| element + | 5 | 0.01 wt % In | 0.01 wt % Zn | ⊚ | ⊚ | ⊚ |
| Oxidation | 6 | 0.01 wt % Ag | 0.01 wt % Mn | ⊚ | ⊚ | ⊚ |
| control element) | 7 | 0.01 wt % Au | 0.01 wt % V | ⊚ | ⊚ | ⊚ |
| | 8 | 0.01 wt % Ni | 0.01 wt % Si | ⊚ | ⊚ | ⊚ |
| | 9 | 0.01 wt % Ni | 0.01 wt % P | ⊚ | ⊚ | ⊚ |
| | 10 | 0.01 wt % Ni | 0.01 wt % Zn | ⊚ | ⊚ | ⊚ |
| | 11 | 0.01 wt % Ni | 0.01 wt % Ge | ⊚ | ⊚ | ⊚ |
| | 12 | 0.01 wt % Ti | 0.01 wt % Mg | ⊚ | ⊚ | ⊚ |
| | 13 | 0.01 wt % Zr | 0.01 wt % Al | ⊚ | ⊚ | ⊚ |
| | 14 | 0.01 wt % Hf | 0.01 wt % Ca | ⊚ | ⊚ | ⊚ |
| | 15 | 0.01 wt % Bi+ | 0.01 wt % P | ⊚ | ⊚ | ⊚ |
| | | 0.01 wt % Ni | | | | |
| | 16 | 0.01 wt % Bi+ | 0.01 wt % Zn | ⊚ | ⊚ | ⊚ |
| | | 0.01 wt % Nl | | | | |
| | 17 | 1 wt % Sb | 0.01 wt % P | ⋆ | ⋆ | ⋆ |
| | 18 | 1 wt % Bi | 0.01 wt % K | ⋆ | ⋆ | ⋆ |
| | 19 | 1 wt % Bi | 0.01 wt % P | ⋆ | ⋆ | ⋆ |
| | 20 | 1 wt % Bi | 0.01 wt % Zn | ⋆ | ⋆ | ⋆ |
| | 21 | 1 wt % In | 0.01 wt % Zn | ⋆ | ⋆ | ⋆ |
| | 22 | 1 wt % Ag | 0.01 wt % Mn | ⋆ | ⋆ | ⋆ |
| | 23 | 1 wt % Au | 0.01 wt % V | ⋆ | ⋆ | ⋆ |
| | 24 | 0.1 wt % Ni | 0.01 wt % Si | ⋆ | ⋆ | ⋆ |
| | 25 | 0.1 wt % Ni | 0.01 wt % P | ⋆ | ⋆ | ⋆ |
| | 26 | 0.1 wt % Ni | 0.01 wt % zn | ⋆ | ⋆ | ⋆ |
| | 27 | 0.1 wt % Ni | 0.01 wt % Ge | ⋆ | ⋆ | ⋆ |
| | 28 | 001 wt % Ti | 0.01 wt % Mg | ⋆ | ⋆ | ⋆ |
| | 29 | 0.1 wt % Zr | 0.01 wt % Al | ⋆ | ⋆ | ⋆ |
| | 30 | 0.1 wt % Hf | 0.01 wt % Ca | ⋆ | ⋆ | ⋆ |
| | 31 | 1 wt % Bi+ | 0.01 wt % P | ⋆ | ⋆ | ⋆ |
| | | 0.1 wt % Ni | | | | |
| | 32 | 1 wt % Bi+ | 0.01 wt % Zn | ⋆ | ⋆ | ⋆ |
| | | 0.1 wt % Nl | | | | |

| | | | | | |
|---|---|---|---|---|---|
| Comparative | 1 | 0.01 wt % Sb | ◯ | ◯ | ◯ |
| Example | 2 | 0.01 wt % Bi | ◯ | ◯ | ◯ |
| (Pure sn + | 3 | 0.01 wt % In | ◯ | ◯ | ◯ |
| Transformation | 4 | 0.01 wt % Ag | ◯ | ◯ | ◯ |
| retardant | 5 | 0.01 wt % Au | ◯ | ◯ | ◯ |
| Element) | 6 | 0.01 wt % Ni | ◯ | ◯ | ◯ |
| | 7 | 0.01 wt % Ti | ◯ | ◯ | ◯ |
| | 8 | 0.01 wt % zr | ◯ | ◯ | ◯ |
| | 9 | 0.01 wt % Hf | ◯ | ◯ | ◯ |
| Comparative | 10 | 0.01 wt % P | ◯ | ◯ | ◯ |
| Example | 11 | 0.01 wt % K | ◯ | ◯ | ◯ |
| (Pure Sn + | 12 | 0.01 wt % Zn | ◯ | ◯ | ◯ |
| Oxidation | 13 | 0.01 wt % Mn | ◯ | ◯ | ◯ |
| control Element) | 14 | 0.01 wt % V | ◯ | ◯ | ◯ |
| | 15 | 0.01 wt % Si | ◯ | ◯ | ◯ |
| | 16 | 0.01 wt % Mg | ◯ | ◯ | ◯ |
| | 17 | 0.01 wt % Al | ◯ | ◯ | ◯ |
| | 18 | 0.01 wt % Ca | ◯ | ◯ | ◯ |
| Conventional art | 1 | None | X | X | X |

⋆: “no whisker” (normal room temperature leaving test: 3000 hr, thermal shock test: 3000 cycles, humidity resistance leaving test: 3000 hr)
⊚: “no whisker” (normal room temperature leaving test: 1000 hr, thermal shock test: 1000 cycles, humidity resistance leaving test: 1000 hr)
◯: a maximum length of the whisker is less than 50 μm (normal room temperature leaving test: 1000 hr, thermal shock test: 1000 cycles, humidity resistance leaving test: 1000 hr)
X: a maximum length of the whisker is not less than 50 μm (normal room temperature leaving test: 1000 hr, thermal shock test: 1000 cycles, humidity resistance leaving test: 1000 hr)

TABLE 2

| | | | | Whisker resistance property | | |
|---|---|---|---|---|---|---|
| | | | | Room | Thermal | Humidity |
| | | | | temperature | shock | resistance |
| Example | Doping metal | | | leaving test | test | leaving test |
| Example | 33 | 0.01 wt % Sb | 0.01 wt % P | ⊚ | ⊚ | ⊚ |
| (Sn—3Ag—0.5Cu + | 34 | 0.01 wt % Bi | 0.01 wt % K | ⊚ | ⊚ | ⊚ |
| Transformation | 35 | 0.01 wt % Bi | 0.01 wt % P | ⊚ | ⊚ | ⊚ |
| retardant | 36 | 0.01 wt % Bi | 0.01 wt % Zn | ⊚ | ⊚ | ⊚ |
| element + | 37 | 0.01 wt % In | 0.01 % wt % Zn | ⊚ | ⊚ | ⊚ |
| Oxidation | 38 | 0.01 wt % Ag | 0.01 wt % Mn | ⊚ | ⊚ | ⊚ |
| control element) | 39 | 0.01 wt % Au | 0.01 wt % V | ⊚ | ⊚ | ⊚ |
| | 40 | 0.01 wt % Ni | 0.01 wt % Si | ⊚ | ⊚ | ⊚ |
| | 41 | 0.01 wt % Ni | 0.01 wt % P | ⊚ | ⊚ | ⊚ |
| | 42 | 0.01 wt % Ni | 0.01 wt % Zn | ⊚ | ⊚ | ⊚ |
| | 43 | 0.01 wt % Ni | 0.01 wt % Ge | ⊚ | ⊚ | ⊚ |
| | 44 | 0.01 wt % Ti | 0.01 wt % Mg | ⊚ | ⊚ | ⊚ |
| | 45 | 0.01 wt % Zr | 0.01 wt % Al | ⊚ | ⊚ | ⊚ |
| | 46 | 0.01 wt % Hf | 0.01 wt % Ca | ⊚ | ⊚ | ⊚ |
| | 47 | 0.01 wt % Bi+ | 0.01 wt % P | ⊚ | ⊚ | ⊚ |
| | | 0.01 wt % Ni | | | | |
| | 48 | 0.01 wt % Bi+ | 0.01 wt % Zn | ⊚ | ⊚ | ⊚ |
| | | 0.01 wt % Nl | | | | |
| | 49 | 1 wt % Sb | 0.01 wt % P | ⋆ | ⋆ | ⋆ |
| | 50 | 1 wt % Bi | 0.01 wt % K | ⋆ | ⋆ | ⋆ |
| | 51 | 1 wt % Bi | 0.01 wt % P | ⋆ | ⋆ | ⋆ |
| | 52 | 1 wt % Bi | 0.01 wt % Zn | ⋆ | ⋆ | ⋆ |
| | 53 | 1 wt % In | 0.01 wt % Zn | ⋆ | ⋆ | ⋆ |
| | 54 | 1 wt % Ag | 0.01 wt % Mn | ⋆ | ⋆ | ⋆ |
| | 55 | 1 wt % Au | 0.01 wt % V | ⋆ | ⋆ | ⋆ |
| | 56 | 0.1 wt % Ni | 0.01 wt % Si | ⋆ | ⋆ | ⋆ |
| | 57 | 0.1 wt % Ni | 0.01 wt % P | ⋆ | ⋆ | ⋆ |
| | 58 | 0.1 wt % Ni | 0.01 wt % Zn | ⋆ | ⋆ | ⋆ |
| | 59 | 0.1 wt % Ni | 0.01 wt % Ge | ⋆ | ⋆ | ⋆ |
| | 60 | 001 wt % Ti | 0.01 wt % Mg | ⋆ | ⋆ | ⋆ |
| | 61 | 0.1 wt % Zr | 0.01 wt % Al | ⋆ | ⋆ | ⋆ |
| | 62 | 0.1 wt % Hf | 0.01 wt % Ca | ⋆ | ⋆ | ⋆ |
| | 63 | 1 wt % Bi+ | 0.01 wt % P | ⋆ | ⋆ | ⋆ |
| | | 0.1 wt % Ni | | | | |
| | 64 | 1 wt % Bi+ | 0.01 wt % Zn | ⋆ | ⋆ | ⋆ |
| | | 0.1 wt % Nl | | | | |

| | | | | | |
|---|---|---|---|---|---|
| Comparative | 19 | 0.01 wt % Sb | ◯ | ◯ | ◯ |
| Example | 20 | 0.01 wt % Bi | ◯ | ◯ | ◯ |
| (Sn—3Ag—0.5Cu + | 21 | 0.01 wt % In | ◯ | ◯ | ◯ |
| Transformation | 22 | 0.01 wt % Ag | ◯ | ◯ | ◯ |
| retardant | 23 | 0.01 wt % Au | ◯ | ◯ | ◯ |
| Element) | 24 | 0.01 wt % Ni | ◯ | ◯ | ◯ |
| | 25 | 0.01 wt % Ti | ◯ | ◯ | ◯ |
| | 26 | 0.01 wt % Zr | ◯ | ◯ | ◯ |
| | 27 | 0.01 wt % Hf | ◯ | ◯ | ◯ |
| Comparative | 28 | 0.01 wt % P | ◯ | ◯ | ◯ |
| Example | 29 | 0.01 wt % K | ◯ | ◯ | ◯ |
| (Sn—3Ag—0.5Cu + | 30 | 0.01 wt % Zn | ◯ | ◯ | ◯ |
| Oxidation | 31 | 0.01 wt % Mn | ◯ | ◯ | ◯ |
| control Element) | 32 | 0.01 wt % V | ◯ | ◯ | ◯ |
| | 33 | 0.01 wt % Si | ◯ | ◯ | ◯ |
| | 34 | 0.01 wt % Mg | ◯ | ◯ | ◯ |
| | 35 | 0.01 wt % Al | ◯ | ◯ | ◯ |
| | 36 | 0.01 wt % Ca | ◯ | ◯ | ◯ |
| Conventional art | 2 | None | X | X | X |

⋆: “no whisker” (normal room temperature leaving test: 3000 hr, thermal shock test: 3000 cycles, humidity resistance leaving test: 3000 hr)
⊚: “no whisker” (normal room temperature leaving test: 1000 hr, thermal shock test: 1000 cycles, humidity resistance leaving test: 1000 hr)
◯: a maximum length of the whisker is less than 50 μm (normal room temperature leaving test: 1000 hr, thermal shock test: 1000 cycles, humidity resistance leaving test: 1000 hr)
X: a maximum length of the whisker is not less than 50 μm (normal room temperature leaving test: 1000 hr, thermal shock test: 100 cycles, humidity resistance leaving test: 1000 hr)

As shown in TABLE 1 and TABLE 2, in the Conventional arts 1 and 2 using the wiring member comprising a pure Sn doped with no dopant and the wiring member comprising the Sn-3 wt % Ag-0.5 wt % Cu alloy doped with no dopant, respectively, the maximum length of whisker is not less than 50 μm. The whisker suppressing effect cannot be obtained at all.

On the other hand, in the Comparative Examples 1 to 36 using the wiring members doped with any one of the transformation retardant element and the oxidation control element, the maximum length of whisker is less than 50 μm, namely the length of the whisker in the respective wiring members is shortened compared with the Conventional arts 1 and 2. The whisker suppressing effect can be obtained in the all of the Comparative Examples 1 to 36.

In comparison, in the Examples 1 to 64 using the wiring members doped with both of the transformation retardant element and the oxidation control element, no whisker was generated after the respective tests for evaluating the whisker resistance property. Compared with the Comparative Examples 1 to 36, a higher whisker suppressing effect can be obtained in the Examples 1 to 64.

Particularly in the Examples 17 to 32 and the Examples 49 to 64 using the wiring member doped with 0.1 wt % or more of the transformation retardant element, no whisker was generated although the respective testing times and testing cycles tripled (normal room temperature leaving test: 3000 hr, thermal shock test: 3000 cycles, humidity resistance leaving test: 3000 hr). Therefore, it is confirmed that the whisker suppressing effect is significantly high.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A Pb-free Sn-based material, comprising:
a base metal doped with a first dopant comprising a transformation retardant element which retards a transformation of a crystal structure, and a second dopant comprising an oxidation control element which is different from the transformation retardant element.

2. The Pb-free Sn-based material according to claim 1, wherein:
the oxidation control element comprises at least one element selected from a group consisted of Sb, Bi, Cd, In, Ag, Au, Ni, Ti, Zr, and Hf, and the oxidation control element comprises at least one element selected from a group consisted of Ge, Zn, P, K, Cr, Mn, Na, V, Si, Al, Li, Mg and Ca.

3. The Pb-free Sn-based material according to claim 1, wherein:
a doping amount of the first dopant is not more than 10 wt %, and a doping amount of the second dopant is not more than 10 wt %.

4. A wiring conductor comprising:
a Sn-based material part provided at least at a part of its surface, the Sn-based material part comprising a base metal doped with a first dopant comprising at least one element selected from a group consisted of Sb, Bi, Cd, In, Ag, Au, Ni, Ti, Zr, and Hf, and a second dopant comprising at least one element selected from a group consisted of Ge, Zn, P, K, Cr, Mn, Na, V, Si, Al, Li, Mg and Ca;
wherein at least one of the Sn, the first dopant and the second dopant is diffused.

5. The wiring conductor according to claim 4, wherein:
a doping amount of the first dopant is not more than 10 wt %, and a doping amount of the second dopant is not more than 10 wt %.

6. The wiring conductor according to claim 4, wherein:
at least one of the Sn, the first dopant and the second dopant is diffused by a reflow process.

7. The wiring conductor according to claim 4 further comprising:
a core composed of a Cu-based material;
wherein the core is coated with a coating layer composed of the Sn-based material part.

8. The wiring conductor according to claim 4, wherein:
the Sn-based material part comprises a solder material or a brazing-filler material.

9. A wiring conductor comprising:
a metal conductor;
a Sn-based material part provided at least at a part of a surface of the metal conductor;
a first layer including a first dopant comprising at least one element selected from a group consisted of Sb, Bi, Cd, In, Ag, Au, Ni, Ti, Zr, and Hf; and
a second layer including a second dopant comprising at least one element selected from a group consisted of Ge, Zn, P, K, Cr, Mn, Na, V, Si, Al, Li, Mg and Ca;
wherein at least one of the Sn, the first dopant and the second dopant is diffused.

10. The wiring conductor according to claim 9, wherein:
the first layer and the second layer are provided on the metal conductor.

11. The wiring conductor according to claim 9, wherein:
the first layer and the second layer are provided on the Sn-based material part.

12. The wiring conductor according to claim 9, wherein:
the first layer is provided on the second layer.

13. The wiring conductor according to claim 9, wherein:
the second layer is provided on the first layer.

14. A connecting assembly comprising:
a terminal to be connected to another terminal, at least one of the terminals comprising a wiring conductor,
wherein the wiring conductor comprises:
a Sn-based material part provided at least at a part of its surface, the Sn-based material part comprising a base metal doped with a first dopant comprising at least one element selected from a group consisted of Sb, Bi, Cd, In, Ag, Au, Ni, Ti, Zr, and Hf, and a second dopant comprising at least one element selected from a group consisted of Ge, Zn, P, K, Cr, Mn, Na, V, Si, Al, Li, Mg and Ca;
wherein at least one of the Sn, the first dopant and the second dopant is diffused.

15. The connecting assembly according to claim 14, wherein:
one of the terminals to be connected to each other is a connector pin of a connector.

16. A Pb-free solder alloy comprising:
Ag of 0.1 to 5 wt %;
Cu of 0.1 to 5 wt %;
a first dopant of not more than 10 wt %, the first dopant comprising at least one element selected from a group consisted of Sb, Bi, Cd, In, Ag, Au, Ni, Ti, Zr, and Hf;
a second dopant of not more than 10 wt %, and the second dopant comprising at least one element selected from a group consisted of Ge, Zn, P, K, Cr, Mn, Na, V, Si, Al, Li, Mg and Ca; and
Sn as a remaining part.
